(19) United States
(12) Patent Application Publication
(10) Pub. No.: US 2026/0042676 A1
(43) Pub. Date: Feb. 12, 2026

(54) System and Process for Reducing Chemical Losses in Treating Ash Produced in a Recovery Boiler of a Wood Pulping Process

(71) Applicant: Veolia Water Technologies, Inc., Cary, NC (US)

(72) Inventors: Michael S. Begley, Lisle, IL (US); Peter Zurowski, La Grange, IL (US); Sebastien Bessenet, Meyssac (FR)

(21) Appl. No.: 19/144,992

(22) PCT Filed: Jan. 9, 2024
(86) PCT No.: PCT/US2024/010818

§ 371 Date: Jul. 1, 2025

Related U.S. Application Data
(60) Provisional application No. 63/438,122, filed on Jan. 10, 2023.

(51) Int. Cl. C01D 5/00; B01D 21/26; B01D 61/02; C22B 3/22; C22B 26/10

(52) U.S. Cl. CPC C01D 5/00; B01D 21/262; B01D 61/027; C22B 3/22; C22B 26/10

(57) ABSTRACT

The present invention relates to a process for treating ash recovered from a recovery boiler. The process is designed to recover valuable pulping chemicals, such as potassium, sodium, carbonate, and sulfate. In the course of treating the ash, a chloride-rich purge stream is produced and includes sulfate, carbonate, potassium, and sodium that can be beneficially used in a wood pulping process. To segregate the chloride from the beneficial chemicals, the chloride-rich purge stream is directed into an anion segregation unit such as a nanofiltration or ion exchange unit. This effectively separates or removes the chloride from the purge stream and enables the beneficial chemicals to be recycled and used in the wood pulping process.

### FIELD OF THE INVENTION

Wood pulping processes typically include a system and process for treating ash that results from burning concentrated black liquor in a recovery boiler. Systems and processes for treating ash are typically designed to recover pulping chemicals such as carbonates and sulfates that are useful in pulp mills. Chlorine (CI) present in pulp mills in the form of chloride has a negative effect on the recovery of these chemicals. One approach for dealing with chloride is to purge a chloride-rich stream from the process. See U.S. Pat. No. 8,721,837 (the '837 patent) and U.S. Pat. No. 9,574,303, the disclosures of which are expressly incorporated herein.

In the '837 patent, a dissolved ash solution is first concentrated in an evaporative crystallizer and then subjected to a Glaserite (3K₂SO₄·Na₂SO₄) crystallizer that produces a glaserite slurry and a purge stream rich in chloride which is directed from the process. The problem is that the chloride-rich purge stream includes some of the chemicals (sodium, carbonate and sulfate) that are useful in the wood pulping process and potassium that can be recovered as potassium sulfate (Sulfate of Potash, aka SOP) hence these useful chemicals are effectively wasted.

### SUMMARY OF THE INVENTION

In a wood pulping process, ash is recovered from a recovery boiler. As noted above, the ash includes substantial amounts of valuable pulping chemicals, such as sodium, carbonate, and sulfate. In the course of treating the ash to recover sodium sulfate and burkeite and possibly produce sulfate of potash, and a chloride-rich purge stream is typically produced. This chloride-rich purge stream includes a substantial amount of sulfate, carbonate, as well as sodium, that can be beneficially used in the wood pulping process. The present invention relates to a process for treating this chloride-rich purge stream so as to recover sulfate, carbonate, potassium, and sodium. Essentially, the process effectively removes chloride from the chloride-rich purge stream, leaving a treated stream with these valuable chemicals that can be used in the wood pulping process.

In one embodiment, the present invention entails a method of treating ash produced in a wood pulping process that comprises the following steps:
a. recovering ash from a recovery boiler in the wood pulping process;
b. mixing the ash with an aqueous solution in an ash dissolution tank and dissolving the ash in the aqueous solution to form a dissolved ash solution containing sodium, chloride, potassium, carbonates, and sulfates;
c. concentrating the dissolved ash solution by producing Sodium salts that are recovered to the recovery process and in the process of concentrating the dissolved ash solution, producing a glaserite slurry and a chloride-rich purge stream containing sodium, potassium, carbonates and sulfates;
d. recovering sulfate of potash (SOP) from the glaserite slurry;
e. recovering the sodium, potassium, sulfate and carbonate from the chloride-rich purge stream by subjecting the chloride-rich purge stream to treatment in an anion segregation unit which produces a treated stream depleted in chloride and containing sodium, potassium, carbonate and sulfate; and
f. recycling the treated stream containing sodium, potassium, carbonate, and sulfate and a small fraction of the Chloride to said ash dissolution tank and mixing the treated stream with the ash in the ash dissolution tank.

Another embodiment entails a slightly different process for treating ash produced in a wood pulping process. In this embodiment, the method comprises:
a. recovering ash from a recovery boiler in the wood pulping process;
b. directing the ash to an ash leaching tank;
c. mixing water or an aqueous solution with the ash and leaching chloride from the ash which yields a slurry of sodium sulfate and burkeite crystals and a solution containing sodium, potassium, chloride, sulfate, and carbonate;
d. subjecting the slurry of sodium sulfate and burkeite crystals and solution containing chloride, sodium, potassium, sulfate, and carbonate to a solid-liquid separator which produces a slurry or wetcake and a centrate rich in chloride and containing sodium, potassium, sulfate, and carbonate;
e. returning the slurry or wetcake to the wood pulping process;
f. recovering sodium, potassium, carbonate and sulfate from the centrate rich in chloride by subjecting the centrate to a nanofiltration process or an ion exchange process which produces a purge stream rich in chloride and a recycle stream depleted in chloride but including sodium, potassium, carbonate and sulfate; and
g. recycling the recycle stream depleted in chloride but including sodium, potassium, carbonate and sulfate to the ash leaching tank where the recycle stream is mixed with the ash and the aqueous solution.

Other objects and advantages of the present invention will become apparent and obvious from a study of the following description and the accompanying drawings which are merely illustrative of such invention.

### BRIEF DESCRIPTION OF THE DRAWINGS

FIG. 1 is a schematic illustration of a method or process for treating ash from a recovery boiler employed in a wood pulping process.

FIG. 2 is a schematic illustration of an alternate process for treating ash from a recovery boiler employed in a wood pulping process.

### DESCRIPTION OF EXEMPLARY EMBODIMENTS

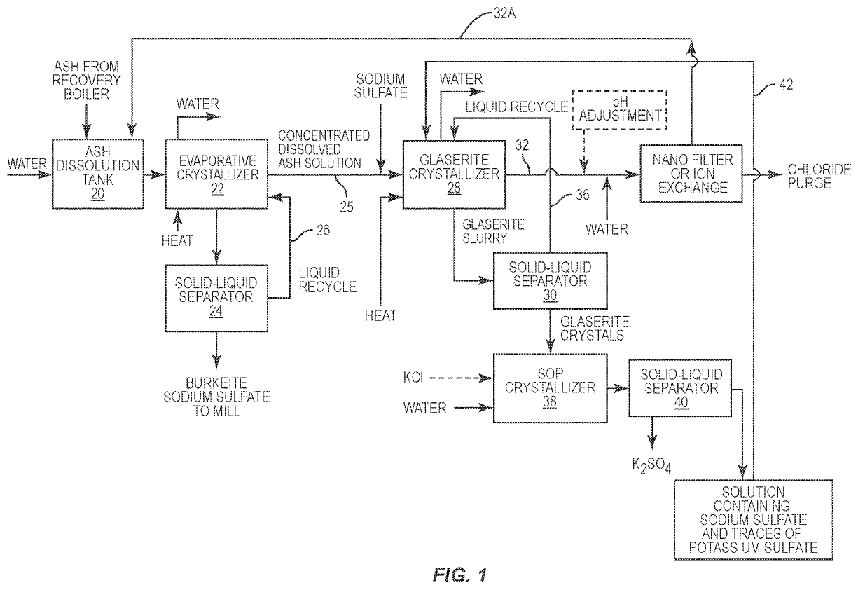

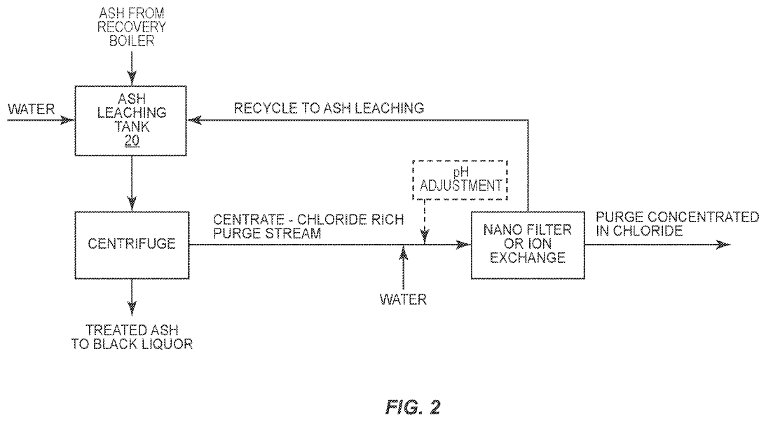

FIG. 1 illustrates a process for treating ash produced in a recovery boiler of a wood pulping process. Before discussing the overall process in detail, one aim of the present invention is to provide a process for treating the ash that facilitates a substantial recovery of valuable chemicals that can be recycled and used in the treatment of ash, as well as in the overall wood pulping process. Because of the presence of chloride in the ash, the process of the present invention purges a significant amount of the chloride from the process. However, in the chloride purge stream are valuable wood pulping chemicals that can be used in other parts of the wood pulping process or recovered as valuable fertilizer (SOP). Hence, the process effectively separates the chloride from a chloride-rich purge stream which leaves a treated stream that includes the valuable chemicals that the invention aims to recover and reuse. As explained below, in one embodiment, the process employs an anion segregation unit such as a nanofiltration unit or an ion exchange unit to effectively separate chloride in the purge stream from the valuable chemicals that are targeted for recovery. As used herein, the term “anion segregation unit” means a device or unit that is effective to separate chloride in a liquid solution from other ions and compounds in the liquid solution. This is illustrated in the processes as shown in FIGS. 1 and 2.

With particular reference to FIG. 1, ash from a recovery boiler is directed into a dissolution tank 20, where the ash is dissolved in water. In some cases, all or substantially all of the ash from the recovery boiler is directed into tank 20. In other cases, only a portion of the ash from the recovery boiler is directed into the tank 20. Ash directed into tank 20 is dissolved to form a dissolved ash solution. The dissolved ash solution is directed to an evaporative crystallizer 22. Evaporative crystallizer 22 concentrates the dissolved ash solution to form a concentrated dissolved ash solution (purge stream) and a concentrate containing a mixture of sodium sulfate and burkeite (2NaSo₄·Na₂So₃) crystals. The concentrated dissolved ash solution is typically relatively rich in chloride and potassium. Concentrate produced by the evaporative crystallizer 22 is directed to a solid-liquid separator 24 which separates burkeite and sodium sulfate crystals from a mother liquor. Burkeite and sodium sulfate are typically returned to the wood pulping operation. Mother liquor produced by the solid-liquid separator 24 is returned via line 26 back to the evaporative crystallizer 22.

As seen in FIG. 1, the purge stream in the form of the concentrated ash solution is directed through line 25 to a glaserite crystallizer 28. Once in the crystallizer 28, the concentrated ash solution is subjected to cooling, and preferably adiabatic cooling. Adiabatic cooling is the decrease of the temperature of the system without removal of heat from the system. One common method of adiabatic cooling is to lower the pressure in the crystallizer, and since temperature and pressure of a closed system are directly proportional, decreasing one will result in the decrease of the other. In one embodiment, the adiabatic cooling process in the glaserite crystallizer 28 is carried out until the crystallizer 28 reaches a temperature of approximately 50° C. In the crystallizer 28, the adiabatic cooling process will cause glaserite to crystallize. This forms a glaserite slurry that is directed from the crystallizer 28 to a solid-liquid separator 30. In the process of adiabatically cooling the concentrated ash solution in stream 25, crystallizer 28 produces a purge stream 32. Purge stream 32 includes a relatively rich concentration of chloride. Besides the rich concentration of chloride, purge stream 32 may include valuable chemicals, such as sodium, potassium, sulfate, and carbonate, that can be used in various parts of the wood pulping process.

Before discussing the further treatment of the chloride-rich purge stream 32, the processing of the glaserite slurry produced by the glaserite crystallizer 28 is addressed. Glaserite slurry produced by the adiabatic cooling crystallizer 28 is directed to a solid-liquid separator 30. Various types of solid-liquid separators can be employed such as filters, centrifuges, etc. In any event, the solid-liquid separator 30 separates glaserite crystals from the glaserite slurry. The glaserite crystals are then directed into an SOP crystallizer 38. The function of the SOP crystallizer 38 is to recover SOP from the glaserite crystals. To accomplish this, water is directed into the SOP crystallizer 38. The water can be chilled to a temperature in the range of 0° C. to 25° C. Here the glaserite crystals are contacted with the water. Once the glaserite crystals contact the water in the SOP crystallizer 38, the sodium sulfate, and potassium sulfate in the glaserite crystals dissolve in the water. After dissolving, some of the potassium sulfate re-crystallizes in the SOP crystallizer as SOP. As such, when enough water is added to dissolve the sodium sulfate, there will be extra SOP remaining as crystals. Hence, what is left in the SOP crystallizer 38 is a sodium sulfate and SOP solution containing re-crystallized SOP.

The re-crystallized SOP is recovered through a process where the sodium sulfate-rich solution is directed to a solid-liquid separator 40 which separates the re-crystallized SOP from the sodium sulfate-rich solution. As FIG. 1 depicts the sodium sulfate solution may contain potassium sulfate. This solution can be recycled via line 42 back to the glaserite crystallizer 28.

As alluded to above, the glaserite crystallizer 28 produces a chloride-rich purge stream 32 that includes valuable chemicals that can be used in wood pulping processes. One of the aims of this invention is to provide an effective and efficient process for recovering these valuable chemicals from the chloride-rich purge line 32. To achieve this aim and as shown in FIG. 1, the chloride-rich purge stream is directed into what is referred to as an anion segregation unit. Prior to being directed into the anion segregation unit, the chloride-rich purge stream may be cooled. Also, water is typically added to the chloride-rich purge stream. The anion segregation unit is effective to remove chloride from the purge stream and permits useful chemicals, such as sodium, carbonate, and sulfate, to be effectively separated from the chloride and recycled back into the process of FIG. 1. Various anion segregation units can be employed. As suggested in FIG. 1, two options include a nanofiltration unit or an ion exchange unit. In either case, the chloride-rich stream 32 is directed into the nanofiltration unit or the ion exchange unit and either is effective to remove the chloride. In the case of a nanofiltration unit, the chloride-rich purge stream is directed into the nanofiltration unit, which in turn produces a permeate and a retentate. Chloride and an equivalent amount of sodium and potassium pass through the nanofiltration unit while the useful chemicals, i.e. sodium, potassium, carbonate, and sulfate, are rejected and become a part of what is referred to as a treated stream 32A. Here, the treated stream 32A includes the beneficial chemicals, such as potassium, sodium, carbonate, and sulfate. Permeate from the nanofiltration unit will then be heavily concentrated in chloride. It should be noted that in some cases it is desirable to adjust the pH of the chloride-rich purge stream for treatment in the nanofiltration unit. Generally, the pH adjustment is downward to a range of approximately 9-11.5, and preferably to a range of approximately 10-11. Sulfuric acid or sesquisulfate from the bleach plant can be used to lower the pH.

Essentially the same results are obtained with an ion exchange unit. That is, by appropriately selecting an ion exchange having an anion exchange resin that selectively removes chloride, the chloride in the chloride purge stream 32 is removed. In this case, the chloride purge stream 32 is directed into and through the ion exchange and the resin therein collects the chloride. The treated effluent from the ion exchange includes the pulping chemicals that can be recycled via line 32A back to the ash leaching tank 20. At various times, the resin in the ion exchange unit that has collected the chloride will require regeneration. Hence, a regenerate fluid is directed through the ion exchange and collects the chloride and yields a regeneration waste stream that is removed from the process. The regeneration waste stream can be further treated or appropriately discharged.

Now, turning to the FIG. 2 embodiment, this also shows a process for treating ash resulting from burning black liquor in a recovery boiler. The ash recovered from the recovery boiler is directed to an ash leaching tank. There, water or an aqueous solution is mixed with the ash. Chloride and potassium are leached from the ash and this yields a slurry of sodium sulfate and burkeite crystals, along with a solution containing sodium, potassium, chloride, sulfate and carbonate. Thereafter, the slurry containing sodium sulfate and burkeite crystals, along with the solution containing sodium, potassium, chloride, sulfate and carbonate, is directed to a solid-liquid separator. In the example illustrated in FIG. 2, the solid-liquid separator is a centrifuge. The centrifuge produces a slurry or wet cake that is recycled to the wood pulping process. Further, the centrifuge produces a centrate containing the valuable chemicals, i.e. sodium, sulfate and carbonate.

Centrate produced by the centrifuge is mixed with water downstream of the centrifuge. After being mixed with the water, the centrifuge is directed to a nanofiltration unit or an ion exchange unit, both of which function as described above with respect to the embodiment shown in FIG. 1. In the case of the nanofiltration unit, the centrate rich in chloride is directed into the nanofiltration unit, which produces a permeate and a retentate. Since the chloride and an equivalent amount of sodium and potassium pass through the membrane of the nanofiltration unit, the permeate constitutes a purge stream that remains rich in chloride and the purge stream can be discharged from the process or subjected to further treatment. Retentate produced by the nanofiltration unit may include the valuable pulping chemicals, such as the carbonates and sulfates, and are recycled back to the ash leaching tank 20. If an ion exchange unit is used in lieu of a nanofiltration unit, it will function and perform as described above.

Beyond recovering useful pulping chemicals, there are number of advantages that flow from this invention. By treating the chloride-rich purge stream as described above, the water load required to dilute the salts to a reasonable concentration is reduced to an amount that is small enough to not increase the evaporation load in the evaporators. This is because the retentate produced by the nanofiltration unit or the recovered treated brine from the ion exchange unit produces a stream that is much smaller than if the treatment occurred upstream of the evaporative crystallizer 22. Positioning the nanofiltration or ion exchange units downstream of the glaserite crystallizer 28 reduces the potassium losses and also yields a chloride-rich purge stream that has a temperature closer to the desirable temperatures for the nanofiltration and ion exchange units. In addition, the process significantly improves SOP production since there is much less potassium lost in the final purge stream. Placing an anion segregation device on the purge stream instead of using it upstream of the evaporative crystallizer 22 substantially reduces the amount of water required for dilution. Also, the process described above allows potassium chloride (KCl) to be added to the SOP crystallizer 38. By removing the chloride without removing large amounts of sulfate and carbonate, adding potassium chloride to produce extra SOP becomes economically feasible. Since pulping mills typically have an excess of sulfate, this process can effectively use the extra sulfate to convert potassium chloride into a higher value SOP.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A method of treating ash produced in a wood pulping process comprising:
recovering ash from a recovery boiler of the wood pulping process;
mixing the ash with an aqueous solution in an ash dissolution tank and dissolving the ash in the aqueous solution to form a dissolved ash solution containing sodium, chloride, potassium, carbonate, and sulfate;
concentrating the dissolved ash solution and in the process of concentrating the dissolved ash solution, producing a glaserite slurry and a chloride-rich purge stream containing the sodium, potassium, carbonate and sulfate;
recovering sulfate of potash (SOP) from the glaserite slurry;
recovering the potassium, sodium, sulfate and carbonate from the chloride-rich stream by subjecting the chloride-rich stream to treatment in an anion segregation unit which produces a treated stream depleted in chloride and containing the sodium, potassium, carbonate and sulfate; and
recycling the treated stream containing the sodium, potassium, carbonate and sulfate to said ash dissolution tank and mixing the treated stream with the ash in the ash dissolution tank.

2. The method of claim 1 wherein the anion segregation unit comprises a nanofiltration unit or an ion exchange unit.

3. The method of claim 1 including adding water to the chloride-rich stream prior to subjecting the chloride-rich stream to treatment in the anion segregation unit.

4. The method of claim 1 further including:
separating glaserite crystals from the glaserite slurry;
directing the glaserite crystals and water into a sulfate of potash (SOP) crystallizer and contacting the glaserite crystals with the water;
dissolving the glaserite crystals in the water in the SOP crystallizer to yield a solution containing sodium sulfate and the SOP;
recrystallizing a portion of the SOP in the potassium sulfate crystallizer, yielding a sodium sulfate-rich solution in the SOP crystallizer; and
directing the sodium sulfate-rich solution containing the recrystallized SOP to a solid-liquid separator and separating the recrystallized SOP from the sodium sulfate-rich solution.

5. The method of claim 2 wherein the anion segregation unit is a nanofiltration unit; and wherein the method includes maintaining the chloride-rich stream at a pH of approximately 9-11.5 prior to entering the nanofiltration unit.

6. A method of treating ash produced in a wood pulping process, comprising:
a. recovering ash from a recovery boiler in a wood pulping process;
b. directing the ash to an ash leaching tank;
c. mixing water or an aqueous solution with the ash in the ash leaching tank and leaching chloride from the ash which yields a slurry comprising sodium sulfate and burkeite crystals and a solution containing sodium, potassium, chloride, sulfate and carbonate;
d. subjecting the slurry comprising the sodium sulfate and burkeite crystals and the solution containing chloride, sulfate and carbonate to a solid-liquid separator and producing a centrate containing sodium, potassium, sulfate and chloride and a concentrate comprising a slurry or wetcake;
e. recycling the slurry or wetcake to the wood pulping process;
f. recovering sodium, potassium, carbonate and sulfate from the centrate rich in chloride by subjecting the centrate to a nanofiltration process or an ion exchange process which produces a purge stream rich in chloride and a recycle stream depleted in chloride but including sodium, carbonate and sulfate; and
g. recycling the recycle stream depleted in chloride but including sodium, potassium, carbonate and sulfate to the ash leaching tank where the recycle stream is mixed with the ash and the water or aqueous solution.

7. The method of claim 6 wherein the solid-liquid separator includes a centrifuge and wherein the centrifuge produces the centrate and the slurry or wetcake.
